(19) United States
(12) Patent Application Publication
(10) Pub. No.: US 2009/0064220 A1
(43) Pub. Date: Mar. 5, 2009

(54) Set-Top Box Emergency Alert System Alarm

(75) Inventors: James Fan, San Ramon, CA (US); Jennifer K. Lam, Fremont, CA (US)

Correspondence Address: AT&T Legal Department, Attn: Patent Docketing, Attn: Patent Docketing Room 2A- 207, One AT & T Way, Bedminster, NJ, 07921, US

(73) Assignee: AT&T Knowledge Ventures, LP, Reno, NV (US)

(21) Appl. No.: 11/847,017

(22) Filed: Aug. 29, 2007

(51) Int. Cl. H04N 7/10

(52) U.S. Cl. 725/33

(57) ABSTRACT

A customer premises device includes a receiving module, a visual module, and an audible module. The receiving module is configured to receive an Internet protocol emergency alert system message. The visual module is in communication with the receiving module, and the visual module is configured to provide a visual alarm based on the Internet protocol emergency alert system message. The audible module is in communication with the receiving module, and the audible module is configured to provide an audible alarm based on the Internet protocol emergency alert system message. A method for outputting the visual and audible alarms is also disclosed.

### FIELD OF THE DISCLOSURE

This invention generally relates to an emergency alert system.

### BACKGROUND

The Emergency Alert System (EAS) was established by the United States Federal Communications Commission (FCC) in November of 1994 with the approval of Part 11 EAS rules. The EAS replaced the Emergency Broadcast System (EBS) as a tool the United States President and others may use to warn the public about emergency situations. Part 11.1 of the EAS rules states the purpose of the EAS:
This part contains rules and regulations providing for an Emergency Alert System (EAS). The EAS provides the President with the capability to provide immediate communications and information to the general public at the National, State and Local Area levels during periods of national emergency. The rules in this part describe the required technical standards and operational procedures of the EAS for AM, FM and TV broadcast stations, cable systems and other participating entities. The EAS may be used to provide the heads of State and local government, or their designated representatives, with a means of emergency communication with the public in their State or Local Area.

Part 11.11(a) of the EAS rules states “the EAS is composed of broadcast networks; cable networks and program suppliers . . . and . . . at a minimum all participants use a common EAS protocol . . . to send and receive alerts . . . .” The Emergency Alert System signal includes a Federal Information Processing Standard (FIPS) number, which is a location code indicating geographic areas affected by an EAS alert. A FIPS code number is a six numeric digit code, formatted as prescribed by the FCC in Part 11 of the EAS rules. Current radio and television broadcast stations broadcast the EAS message to the entire designated market area (DMA) even though many customers in the DMA are not affected by the EAS message. The EAS message received from the radio and television broadcast stations are typically outputted as audio and/or text on a radio or television of the customer.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of an Internet protocol television (IPTV) system;

FIG. 2 is a front plan view of a video monitoring system;

FIG. 3 is a rear plan view of the video monitoring system;

FIG. 4 is a plan view of a remote control device;

FIG. 5 is a block diagram of a Internet Protocol emergency alert notification system;

FIG. 6 is a block diagram of an emergency alert system enabled IPTV system;

FIG. 7 is a flow chart of a method for outputting a visual alarm and an audible alarm in response to receiving an Internet Protocol formatted emergency alert system message; and

FIG. 8 is a block diagram of an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

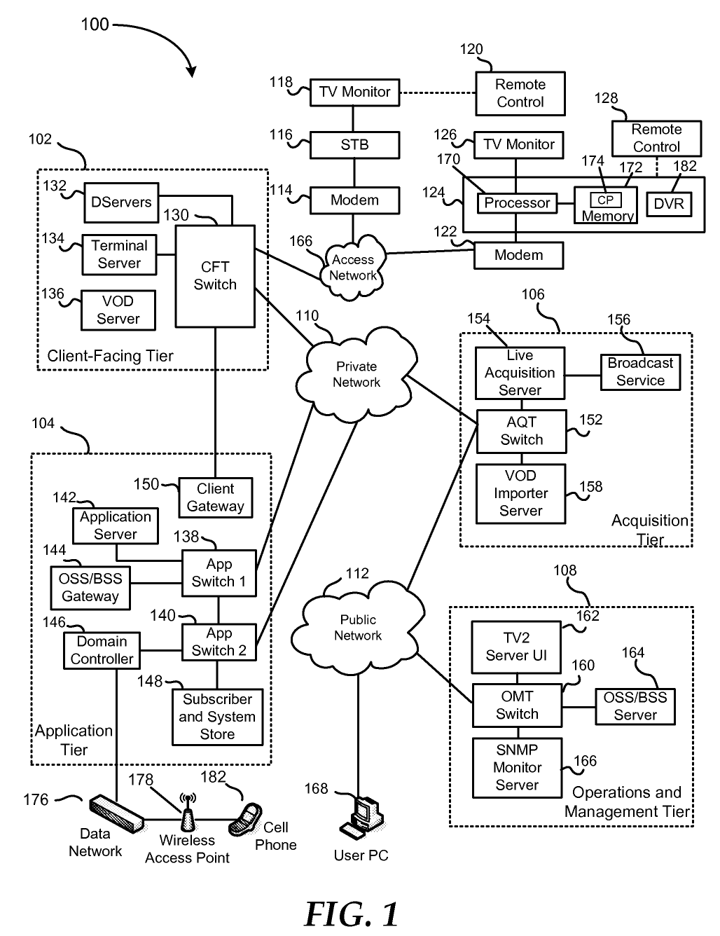

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to a public network such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box (STB) device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include an STB processor 170 and an STB memory device 172 that is accessible to the STB processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer 168 coupled to the public network 112.

The domain controller 146 communicates with the public network 112 via the second APP switch 140. Additionally, the domain controller 146 can communicate via the public network 112 with the personal computer 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 180.

In a particular embodiment, the set-top box devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating second set-top box device with a user account, or with any combination of these. Further details of the IPTV system are taught in U.S. Patent Application Publication No. 2007/0083895, the disclosure of which is hereby incorporated by reference.

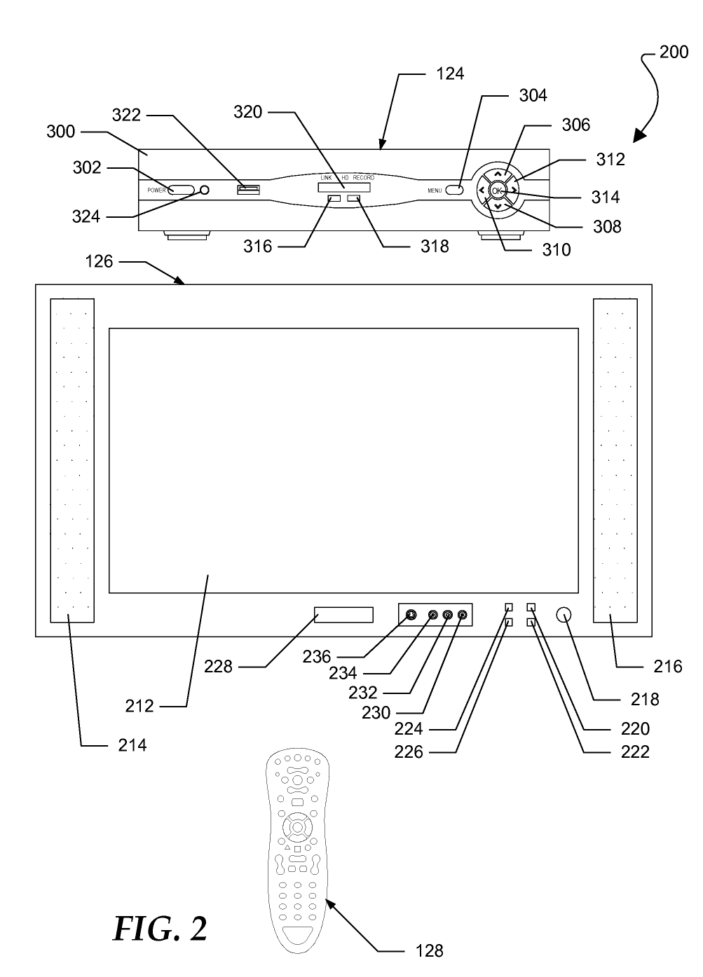

FIG. 2 shows a video system 200 including the display device 126, the IPTV receiver set-top box 124, and the remote control device 128. The display device 126 includes a display screen 212, and speakers 214 and 216. A power button 218, a channel up button 220, a channel down button 222, a volume up button 224, and a volume down button 226 perform well-known functions. The display device 126 also includes an infrared (IR) receiver, a radio frequency (RF) receiver, or a similar receiver 228 incorporated therein. The display device 126 can include a right channel RCA connector 230, a left channel RCA connector 232, and a composite video RCA connector 234. Additionally, the display device 126 can include an S-video connector 236.

The IPTV receiver 124 can include a front panel 300 having a power button 302, a menu button 304, an up button 306, a down button 308, a left button 310, a right button 312, and an OK button 314. The front panel 300 of the IPTV receiver 124 can also include a transmitter 316 and a receiver 318 incorporated therein. In a particular embodiment, the transmitter 316 can be an IR transmitter, an RF transmitter, or a similar transmitter. Further, the receiver 318 can be an IR receiver, an RF receiver, or a similar receiver. The front panel 300 of the IPTV receiver 124 can include a display 320, a universal serial bus (USB) connector 322, and a power-on light 324. The display 320 can be a light emitting diode (LED) display, a liquid crystal display (LCD), or some other display. The power-on light 324 is preferably a light emitting diode (LED).

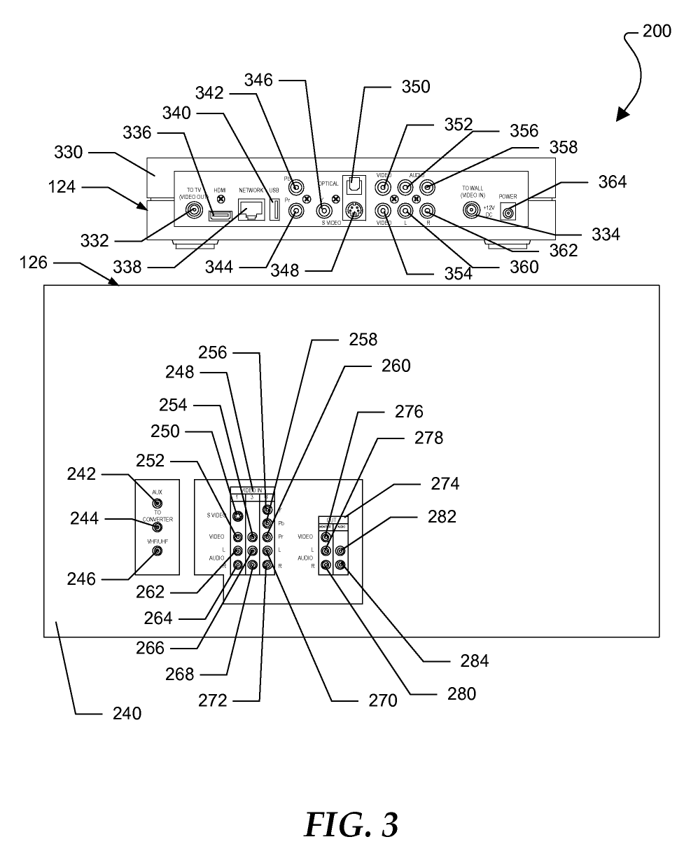

FIG. 3 shows that the display device 126 has a rear panel 240 that can include a plurality of connectors such as a first RF connector 242, a second RF connector 244, and a third RF connector 246. The rear panel 240 can also include a video in panel 248 having an S-video connector 250, a first composite video Radio Corporation of America (RCA) connector 252, and a second composite video RCA connector 254. The video in panel 248 can also include a Y component RCA connector 256, a Pb component RCA connector 258, and a Pr component RCA connector 260. Further, the video in panel 248 can include a first left channel RCA connector 262, a first right channel RCA connector 264, a second left channel RCA connector 266, a second right channel RCA connector 268, a third left channel RCA connector 270, and a third right channel RCA connector 272. The rear panel 240 has a video out panel 274 that can include a composite video RCA connector 276, a first left channel RCA connector 278, a first right channel RCA connector 280, a second left channel RCA connector 282, and a second right channel RCA connector 284.

The IPTV receiver 124 can include a rear panel 330 with a first RF connector 332, a second RF connector 334, a high definition multi-media interface (HDMI) connector 336, a network connection 338, and a USB connection 340. In a particular embodiment, the network connection 338 can be an RJ-45 port and can allow the IPTV receiver 124 to be connected to an IPTV network via an Ethernet cable. The rear panel 330 of the IPTV receiver 124 can also include a Pb component RCA connector 342, a Pr component RCA connector 344, and a Y component RCA connector 346. The rear panel 330 can include an S-video connector 346 and an optical video connector 350. Additionally, the rear panel 330 of the IPTV receiver 124 can include a first composite video RCA connector 352, and a second composite video RCA connector 354. Further, the rear panel 330 of the IPTV receiver 124 can include a first left channel RCA connector 356, a first right channel RCA connector 358, a second left channel RCA connector 360, and a second right channel RCA connector 362. The rear panel 330 of the IPTV receiver 124 can also include a power input connector 364.

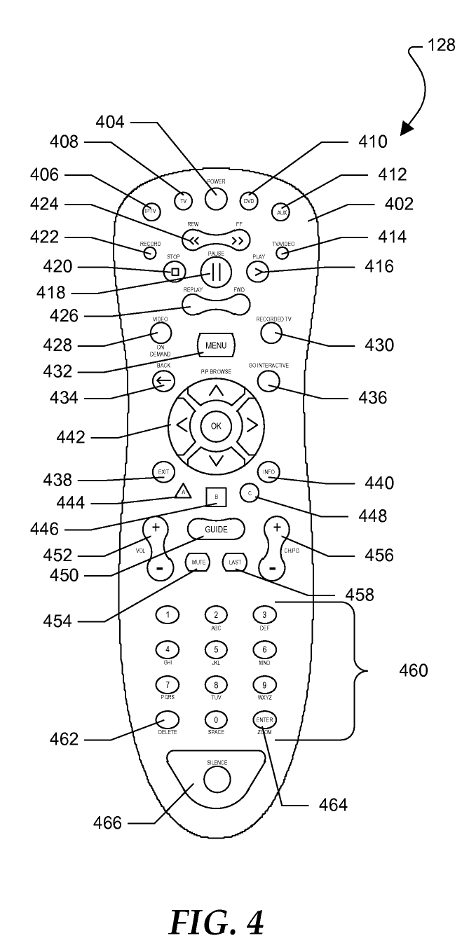

FIG. 4 shows the remote control device 128 including a housing 402 having a plurality of buttons. For example, the remote control device 128 can include a power button 404, an IPTV button 406, a television (TV) button 408, a digital video disc (DVD) button 410, and an auxiliary (AUX) button 412. When the IPTV button 406 is pressed, the remote control device 128 can be used to control the IPTV receiver 124. When the TV button 408 is pressed, the remote control device 406 can be used to control the display device 126 connected to the IPTV receiver 124. When the DVD button 410 is pressed, the remote control device 128 can be used to control a DVD player connected to the display device 126, the IPTV receiver 124, or both. Additionally, when the AUX button 412 is pressed, the remote control device 128 can be used to control an auxiliary device connected to the display device 126, the IPTV receiver 124, or both. For example, the auxiliary device can be a compact disc (CD) player, a video cassette recorder (VCR), an audio receiver, or some other home entertainment device.

The remote control device 128 can include a TV/VIDEO button 414 that can be used to toggle between television content and video content, e.g. from a DVD player. The remote control device 128 can also include a PLAY button 416, a PAUSE button 418, a STOP button 420, a RECORD button 422, a rewind (REW)/fast forward (FF) button 424, and a replay/slow forward (FWD) button 426. These buttons can be used to control the content received at the IPTV receiver or video content received from a DVD player. One or more of these buttons can also be programmed to control a CD player, a VCR, or some other home entertainment device. The remote control device 128 can also include a VIDEO ON DEMAND button 428 and a RECORDED TV button 430. The VIDEO ON DEMAND button 428 can be pressed in order to access on demand video content available via the IPTV receiver. The RECORDED TV button 430 can be pressed in order to access television content recorded at the IPTV receiver.

The remote control device 128 can also include a MENU button 432, a BACK button 434, a GO INTERACTIVE button 436, an EXIT button 438, and an INFO button 440. The MENU button 432 can be used to access a menu of features provided by the IPTV receiver. Further, the INFO button 444 can be used to access an information window provided by the IPTV receiver. The GO INTERACTIVE button 436 can be used to access interactive content provided by the IPTV system. The remote control device 128 can include a directional keypad 442. The directional keypad 442, the BACK button 434, and the EXIT button 438 can be used to navigate within the various content windows provided by the IPTV receiver. The remote control device 128 can also include a triangular A button 444, a square B button 446, and a round C button 448. The A button 444, the B button 446, and the C button 448 can be used to make various selections when navigating within a menu screen, an information screen, or some other screen provided by the IPTV receiver.

The remote control device 128 can further include a GUIDE button 450 that can be pressed in order to access an electronic programming guide for the content provided by the IPTV receiver. Moreover, the remote control device 128 can include a volume (VOL) up/down button 452, a MUTE button 454, a channel/page (CH/PG) up/down button 456, and a LAST button 458. The VOL button 452 can be used to control the volume of an IPTV receiver, a TV, a CD player, etc. The MUTE button 454 can be used to mute audio content provided by an IPTV receiver, a TV, a CD player, etc. The CH/PG button 456 can be used to change the channel at an IPTV receiver or navigate from page-to-page within a content guide provided by an IPTV receiver. The LAST button 458 can be used to return to the last channel viewed by the user at the IPTV receiver.

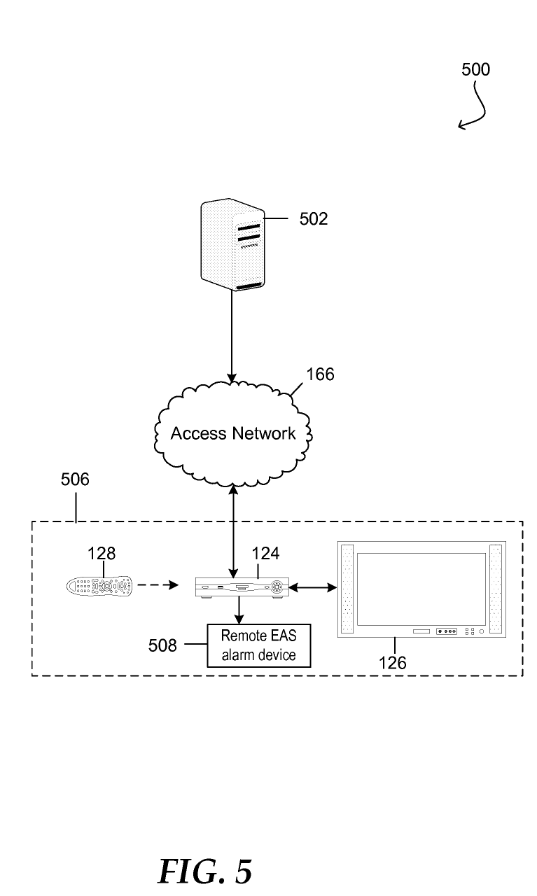

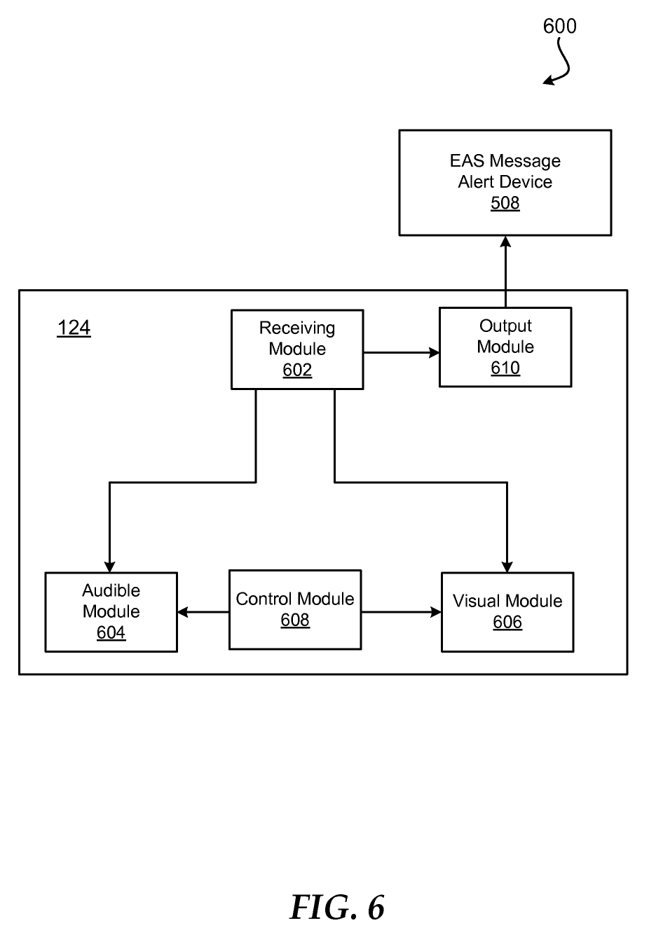

The remote control device 128 can include a numerical keypad 460 having a plurality of buttons that are individually numbered 1, 2, 3, 4, 5, 6, 7, 8, 9, and 0. The numerical keypad 460 is configured similar to a telephone keypad and each individual button also includes a portion of the alphabet. The 2 button includes ABC, the 3 button includes DEF, the 4 button includes GHI, the 5 button includes JKL, the 6 button includes MNO, the 7 button includes PQRS, the 8 button includes TUV, and the 9 button includes WXYZ. The 0 button can also be used as a SPACE button. In a particular embodiment, the numerical keypad 460 can be used to input a specific channel number. Further, the numerical keypad 460 can be used to input text to the IPTV system, when necessary, using the triple tap method well known in the art. The numerical keypad 460 can also include a DELETE button 462 and an ENTER/ZOOM button 464. The remote control device 128 may also include a SILENCE button 466 to end an emergency alert notification, as describe further in FIGS. 5 and 6.

FIG. 5 shows an Internet Protocol (IP) emergency alert notification system 500 including an IPTV server 502 and a customer premises device such as the IPTV receiver 124. It should be appreciated that the IPTV receiver 124, the display device 126, the remote control 128, and a remote emergency alert system (EAS) alarm device 508 in communication with the IPTV receiver may or may not be located on a customer premises 506. Wherever installed, the IPTV receiver 124 is assigned a Federal Information Processing Standards (FIPS) code to identify its location. Whenever the IPTV server 502 thereafter receives a signal containing an EAS message, the IPTV server parses the FIPS code portion of the EAS message to identify those IPTV receivers, such as the IPTV receiver 124, affected by the EAS message. Upon identifying the IPTV receivers with FIPS codes corresponding to those in the EAS message, the IPTV server 502 sends an Internet Protocol (IP) formatted EAS message only to the IPTV receivers affected by the EAS message, instead of every IPTV receiver in the designated market area (DMA). For example, the FIPS code assigned to the IPTV receiver 124 can identify that the IPTV receiver is located in a county that is under a weather warning or watch.

Upon receiving the EAS message, the IPTV receiver 124 outputs a visual alarm and an audible alarm to the user. The visual alarm is preferably a blinking light on the IPTV receiver 124, such as the power-on light 324, and the audible alarm is preferably a sequence of beeps. The IPTV receiver 124 preferably has a plurality of user selectable options for providing the visual and audible alarms to the user, which the user can adjust through the remote control device 128. To set the EAS alarm options, the user preferably presses the MENU button 432 (FIG. 4) on the remote control device 128 and then selects an EAS alarm set-up option from a plurality of menu options. Selecting the EAS alarm set-up option is preferably performed by using the up and down arrows to highlight the EAS alarm set-up option and then pressing the OK button on the directional keypad 442 of FIG. 4.

In the EAS alarm set-up menu, the user preferably has the option to change the pre-set length of time that the IPTV receiver 124 outputs the visual and audible alarms. Also, the user can program a required personal identification number (PIN) code to silence the EAS alarms before the pre-set length has expired. The PIN code is preferably set by pressing a plurality of number buttons of the numerical keypad 460 and then pressing the enter button 464 on the remote control device 128 to save the PIN code. The PIN code is used to ensure that only an authorized individual may turn off the audible and visual alarms before the pre-set time expires. For example, the PIN code enables parents to prevent their children from turning the visual and audible alarms off without permission. Additionally, the user can program the EAS alarm set-up menus to either enable or disable the ability of the IPTV receiver 124 to transmit the EAS message to the remote EAS alarm device 508 by activating or deactivating the USB connection 340 of FIG. 3.

FIG. 6 shows an EAS enabled IPTV system 600 including the IPTV receiver 124 and the remote EAS alarm device 508. The IPTV receiver 124 preferably includes a receiving module 602, an audible module 604, a visual module 606, a control module 608, and an output module 610. The receiving module 602 is preferably in communication with the audible module 604, the visual module 606, and the output module 610. The control module 608 is preferably in communication with the audible module 604 and the visual module 606. The output module 610 is preferably in communication with the remote EAS alarm device 508.

The receiving module 602 can receive the IP formatted EAS message from the IPTV server 502 (FIG. 5) through the access network 166, and decode the EAS message before transmitting EAS message to the display device 126. If the display device 126 is on when the EAS message is received, a text portion of the EAS message is presented to the user on the display screen 212 (FIG. 2) and an audio portion of the EAS message is outputted through the speakers 214 and 216 of the display device. The receiving module 602 also transmits an activation signal to the audible module 604, the visual module 606, and the output module 610.

The audible module 604 preferably creates the audible alarm by generating the sequence of beeps for the pre-set amount of time. The sequence of beeps can notify the user of the IPTV receiver 124 of the EAS message. The visual module 606 preferably produces the visual alarm by making the power-on light 324 (FIG. 2) blink repeatedly for the pre-set amount of time. The IPTV receiver 124 can preferably detect whether the display device 126 is on or off through the HDMI connection 336 (FIG. 3), but the IPTV receiver may not detect whether the display device is muted. Therefore, the visual and audible alarms are outputted to the user without a determination being made as to whether or not the display device 126 is off and/or muted. Thus, every time the IPTV receiver 124 receives an EAS message, the IPTV receiver outputs the visual and audible alarms to the user. The output module 610 preferably sends the EAS message to the remote EAS alarm device 508 through the USB connection 340 (FIG. 3). The remote EAS alarm device 508 may provide additional visual and audible alarms to the user.

While the audible module 604 and the visual module 606 output the visual and audible alarms, the control module 608 waits for a control signal to deactivate the visual and/or audible alarms. The user can transmit the control signal by pressing the SILENCE button 466 and entering the PIN code on the remote control device 128. After the control module 608 receives the control signal and the PIN code, the control module deactivates the audible and/or visual alarms, even if the pre-set amount of time for outputting the alarms is not reached.

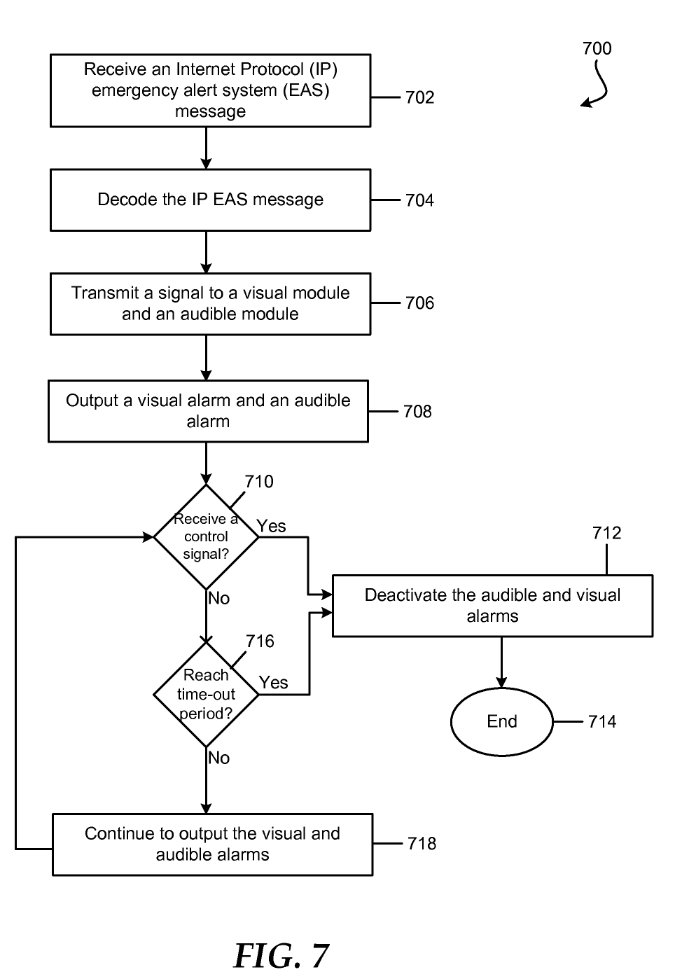

FIG. 7 shows a flow chart of a method 700 for outputting a visual alarm and an audible alarm upon receiving an Internet Protocol (IP) formatted emergency alert system (EAS) message. At block 702, a customer premises device receives the IP formatted EAS message. The customer premises device is preferably any device capable of receiving and processing an IP formatted signal, such as the IPTV receiver, any other type of a set-top box, a computer, and/or an IP telephone. The customer premises device decodes the IP formatted EAS message at block 704.

At block 706, a signal is transmitted to a visual module and an audible module of the customer premises device, in response to the EAS message, to activate the visual module and the audible module. The visual module outputs the visual alarm and the audible module outputs the audible alarm at block 708. At block 710, a determination is made whether the customer premises device receives a control signal requesting that the audible and visuals alarm be deactivated. If the customer premises device receives the control signal, the visual and audible alarms are deactivated at block 712 and the method ends at block 714. However, if the customer premises device does not receive the control signal, the customer premises device determines whether a time-out period is reached at block 716. The time-out period is preferably a pre-determined length of time that the customer premises device outputs the visual and audible alarms before automatically deactivating the alarms.

If the time-out period is not reached, the customer premises device continues to output the visual and audible alarms at block 718. While the customer premises device continues to output the visual alarm and the audible alarm it again determines if the control signal is received at block 710 and the method continues as stated above. However, if the time-out period is reached, the visual alarm and the audible alarm are deactivated at block 712 and the method ends at block 714.

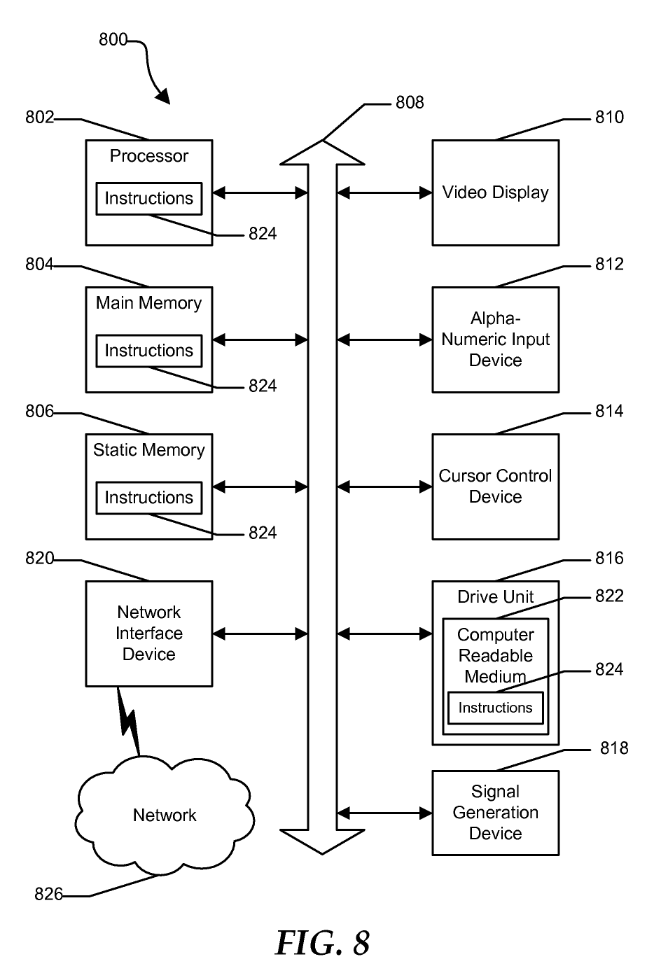

FIG. 8 shows an illustrative embodiment of a general computer system 800. The computer system 800 can include a set of instructions that can be executed to cause the computer system 800 to perform any one or more of the methods or computer based functions disclosed herein. The computer system 800 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, an STB, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

The computer system 800 may include a processor 802 such as a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810 such as a liquid crystal display (LCD), an organic light emitting diode (OLED), a flat panel display, a solid state display, or a cathode ray tube (CRT). Additionally, the computer system 800 may include an input device 812 such as a keyboard, and a cursor control device 814 such as a mouse. The computer system 800 can also include a disk drive unit 816, a signal generation device 818 such as a speaker or remote control, and a network interface device 820 to communicate with a network 826. In a particular embodiment, the disk drive unit 816 may include a computer-readable medium 822 in which one or more sets of instructions 824, such as software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A customer premises device comprising:
a receiving module configured to receive an Internet protocol emergency alert system message;
a visual module in communication with the receiving module, the visual module configured to provide a visual alarm based on the Internet protocol emergency alert system message; and
an audible module in communication with the receiving module, the audible module configured to provide an audible alarm based on the Internet protocol emergency alert system message.

2. The customer premises device of claim 1 further comprising a control module in communication with the audible module, the control module configured to receive a control signal from a user.

3. The customer premises device of claim 2 wherein the audible module is further configured to deactivate the audible alarm in response to the control module receiving the control signal.

4. The customer premises device of claim 2 wherein the visual module is further configured to deactivate the visual alarm in response to the control module receiving the control signal.

5. The customer premises device of claim 1 further comprising an output module in communication with the receiving module, the output module configured to transmit the Internet protocol emergency alert message to an alarm device remote from the customer premises device.

6. The customer premises device of claim 5 wherein the alarm device is configured to output a visual alarm and an audible alarm in response to the emergency alert system message.

7. The customer premises device of claim 1 wherein the customer premises device is a set-top box.

8. A method comprising:
receiving an Internet protocol emergency alert system message;
outputting a visual alarm in response to the Internet protocol emergency alert system message; and
outputting an audible alarm in response to the Internet protocol emergency alert system message.

9. The method of claim 8 further comprising silencing the audible alarm in response to receiving a control signal from a user.

10. The method of claim 9 wherein a personal identification number is required to silence the audible alarm.

11. The method of claim 8 further comprising ending the visual alarm in response to receiving a control signal from a user.

12. The method of claim 11 wherein a personal identification number is required to end the visual alarm.

13. The method of claim 8 further comprising outputting the Internet protocol emergency alert system message to an external alarm device.

14. A computer readable medium including a plurality of instructions to manipulate a processor, the plurality of instructions including:
instructions to generate a visual alert based on an Internet protocol emergency alert system message; and
instructions to generate an audible alert to the user based on an Internet protocol emergency alert system message.

15. The computer readable medium of claim 14 further comprising instructions to receive a control signal from the user in response to the emergency alert system message.

16. The computer readable medium of claim 15 further comprising instructions to silence the audible alert in response to the control module receiving the control signal.

17. The computer readable medium of claim 15 further comprising instructions to end the visual alert in response to the control module receiving the control signal.

18. The computer readable medium of claim 14 further comprising instructions to transmit the emergency alert message to an external alarm device.

19. The computer readable medium of claim 18 wherein the external alarm device is configured to output a visual alarm in response to the emergency alert system message.

20. The computer readable medium of claim 18 wherein the external device is configured to output an audible alarm in response to the emergency alert system message.
